(19) United States
(12) Patent Application Publication
(10) Pub. No.: US 2024/0400759 A1
(43) Pub. Date: Dec. 5, 2024

(54) METHOD FOR PREPARING BIO-POLYOL, COMPOSITION OF POLYURETHANE RESIN CONTAINING BIO-POLYOL, AND METHOD FOR PREPARING POLYURETHANE FOAM USING THE SAME

(71) Applicants: HYUNDAI MOTOR COMPANY, SEOUL (KR); KIA CORPORATION, SEOUL (KR); INDUSTRY-ACADEMIC COOPERATION FOUNDATION GYEONGSANG NATIONAL UNIVERSITY, JINJU-SI (KR)

(72) Inventors: Jung Wook Lee, Seoul (KR); Jeong Seok Oh, Jinju-si (KR); Gyuri Kim, Jinju-si (KR); Seongrok Jeong, Changwon-si (KR); Sarbaranjan Paria, Jinju-si (KR)

(21) Appl. No.: 18/239,409

(22) Filed: Aug. 29, 2023

(30) Foreign Application Priority Data
May 30, 2023 (KR) 10-2023-0068901

(51) Int. Cl. C08G 65/46; C08G 18/08; C08G 18/20; C08G 18/66; C08G 18/72; C08J 9/12

(52) U.S. Cl. CPC C08G 65/46; C08G 18/14; C08G 18/2063; C08G 18/6674; C08G 18/72; C08J 9/125; C08G 2101/00; C08G 2110/0008; C08G 2110/0016; C08G 2110/0083; C08J 2201/022; C08J 2203/10; C08J 2205/06; C08J 2205/08

(57) ABSTRACT

A method of preparing a bio-polyol using coffee by-products, a polyurethane resin composition containing the bio-polyol, and a method of preparing a polyurethane foam using the same are described. The method simplifies the complicated process of extracting polyols from coffee and thus extracts bio-polyols within a short time, thus being advantageous in terms of cost and time.

### CROSS REFERENCE TO RELATED APPLICATIONS

This application claims under 35 U.S.C. § 119(a) the benefit of priority to Korean Patent Application No. 10-2023-0068901, filed on May 30, 2023, the entire contents of which are incorporated herein by reference.

### BACKGROUND

### (a) Technical Field

The present disclosure relates to a method of preparing a bio-polyol using coffee by-products, a polyurethane resin composition containing the bio-polyol, and a method of preparing a polyurethane foam using the same.

### (b) Background Art

A polyurethane foam is prepared by mixing a polyol with isocyanate and additives and is obtained in any one of various forms such as flexible, hard, and semi-rigid foams depending on mixing conditions of the polyol, isocyanate and the like. Flexible polyurethane foams can be used to manufacture furniture, automobile seat foams and the like, while rigid polyurethane foams have good insulation properties and are therefore widely used for energy saving.

Among the raw materials, polyols may be cured while forming macromolecules upon reaction with isocyanate and may be mixed with various types of compounds to control properties after curing. For example, physical and chemical blowing agents may be used to control density and amines and metal catalysts may be added to control curing speed. Accordingly, the structure and characteristics of the blown foams may vary.

Polyols are generally synthesized from petroleum-based raw materials, but recently, research on synthesizing polyols from natural products such as corn, soybeans and olives has been conducted due to high interest in eco-friendliness. In this regard, methods using wasted coffee grounds have been researched, but disadvantageously require one day to perform the entire process because the methods include extracting coffee oils from coffee grounds, modifying the extracted coffee oils to obtain epoxidized coffee oils, and then extracting coffee polyols from the coffee oils using alcohol.

The above information disclosed in this Background section is only for enhancement of understanding of the background of the invention, and therefore it may contain information that does not form the prior art that is already known in this country to a person of ordinary skill in the art.

### SUMMARY

The present disclosure has been made in an effort to solve the above-described problems associated with the prior art and it is one object of the present disclosure to provide a method of preparing a bio-polyol derived from coffee by-products.

It is another object of the present disclosure to provide a foam prepared using the bio-polyol derived from coffee by-products.

It is another object of the present disclosure to provide a method of preparing a foam using the bio-polyol extracted from coffee by-products.

The objects of the present disclosure are not limited to those described above. Other objects of the present disclosure will be clearly understood from the following description, and are able to be implemented by means defined in the claims and combinations thereof.

In one aspect, the present disclosure provides a method of preparing a bio-polyol including mixing coffee by-products including coffee grounds with a polyol solvent mixture.

The polyol solvent mixture may contain a polyol, glycerol, and an acid.

The mixing may be performed at 135 to 200° C. for 0.5 to 48 hours.

The polyol may have a weight average molecular weight of 400 to 8,000 g/mol and a hydroxyl value of 26 to 300 mgKOH/g and may contain 10 to 30% by weight of ethylene oxide (EO), based on a total weight of the polyol.

The acid may include at least one selected from the group consisting of sulfuric acid, adipic acid, phthalic acid, succinic acid, and maleic acid.

The polyol solvent mixture may contain the polyol in an amount of greater than 50.1% by weight, based on the total weight of the polyol solvent mixture.

The polyol solvent mixture may contain the glycerol in an amount of 0.1 to 8% by weight, based on the total weight of the polyol solvent mixture.

The polyol solvent mixture may contain the acid in an amount of 0.8 to 4% by weight, based on the total weight of the polyol solvent mixture.

The mixing may be performed by mixing the coffee by-products and the polyol solvent mixture in a ratio of 20:80 to 45:55.

In another aspect, the present disclosure provides a polyurethane resin composition containing a polyol system including the bio-polyol prepared by the method described above, a first polyol, and a second polyol, an additive including a cell opener, a surfactant, a catalyst, a chain extender, a crosslinking agent, and a blowing agent, and isocyanate.

The first polyol may have a weight average molecular weight of 3,000 to 10,000 g/mol and a hydroxyl value of 24 to 32 mgKOH/g and may contain 10 to 30% by weight of ethylene oxide (EO), based on the total weight of the first polyol.

The second polyol may be a polymer polyol, may have a weight average molecular weight of 6,000 to 9,000 g/mol and a hydroxyl value of 18 to 22 mgKOH/g and may contain 20 to 42% by weight of a solid filler, based on the total weight of the polymer polyol.

The catalyst may include a gelling catalyst and a blowing catalyst.

The polyol system may include the bio-polyol in an amount of 5 to 80 parts by weight, based on 100 parts by weight of the total weight of the first polyol and the second polyol.

The polyurethane resin composition may contain the isocyanate in an amount of 0.5 to 20 times the total weight of the polyol system and the additive.

The additive may include 0.1 to 5 parts by weight of the cell opener, 0.1 to 2 parts by weight of the surfactant, 0.1 to 5 parts by weight of the catalyst, 0.1 to 1 part by weight of the chain extender, 0.1 to 1 part by weight of the crosslinking agent, and 0.1 to 5 parts by weight of the blowing agent, based on 100 parts by weight of the polyol system.

In another aspect, the present disclosure provides a method of preparing a polyurethane resin composition including mixing coffee by-products including coffee grounds with a polyol solvent mixture to prepare a bio-polyol, mixing the bio-polyol with a first polyol, a second polyol, a cell opener, a surfactant, a catalyst, a chain extender, a crosslinking agent, and a blowing agent to prepare a polyol premix, mixing the polyol premix with isocyanate to prepare a polyurethane resin composition, and blowing the polyurethane resin composition.

The preparing the polyurethane resin composition may include mixing the polyol premix with the isocyanate after stirring the polyol premix at 1,400 to 1,600 rpm for at least 15 seconds.

The preparing the polyurethane resin composition may include mixing the polyol premix with the isocyanate in an amount of 0.5 to 20 times the total weight of the polyol premix.

The polyurethane foam obtained as a semi-rigid foam by the method may have a compressive strength of 0.5 kgf/cm² or more, and the polyurethane foam obtained as a soft foam by the method may have a compressive strength of 0.1 to 0.14 kgf/cm².

Other aspects and preferred embodiments of the disclosure are discussed infra.

### BRIEF DESCRIPTION OF THE FIGURES

The above and other features of the present disclosure will now be described in detail with reference to certain exemplary embodiments thereof, illustrated in the accompanying drawings which are given hereinbelow by way of illustration only, and thus are not limitative of the present disclosure, and wherein:

FIG. 1 is an image showing a foam of Example 26 in an experimental example of the present disclosure;

FIG. 2 is an image showing a foam of Comparative Example 7 in an experimental example of the present disclosure;

FIG. 3 is a graph showing sound absorption coefficients of the foams of Example 26 and Comparative Example 7 measured in an experimental example of the present disclosure;

FIG. 4 is a graph showing compressive strengths of the foams of Example 26 and Comparative Example 7 measured in an experimental example of the present disclosure;

FIG. 5 is an image showing a foam of Example 27 in an experimental example of the present disclosure;

FIG. 6 is an image showing a foam of Example 28 in an experimental example of the present disclosure;

FIG. 7 is an image showing a foam of Example 29 in an experimental example of the present disclosure;

FIG. 8 is an image showing a foam of Example 30 in an experimental example of the present disclosure;

FIG. 9 is an image showing a foam of Comparative Example 8 in an experimental example of the present disclosure;

FIG. 10 is an image showing a foam of Comparative Example 9 in an experimental example of the present disclosure;

FIG. 11 is a graph showing sound absorption coefficients of the foams of Examples 27 to 30 and Comparative Example 8 measured in an experimental example of the present disclosure; and

FIG. 12 is a graph showing the compressive strengths of the foams of Examples 27 to 30 and Comparative Example 8 measured in an experimental example of the present disclosure.

### DETAILED DESCRIPTION

The objects described above, as well as other objects, features and advantages, will be clearly understood from the following preferred embodiments with reference to the attached drawings. However, the present disclosure is not limited to the embodiments, and may be embodied in different forms. The embodiments are suggested only to offer a thorough and complete understanding of the disclosed context and to sufficiently inform those skilled in the art of the technical concept of the present disclosure.

Like reference numbers refer to like elements throughout the description of the figures. In the drawings, the sizes of structures may be exaggerated for clarity. It will be understood that, although the terms “first”, “second”, etc. may be used herein to describe various elements, these elements should not be construed as being limited by these terms, which are used only to distinguish one element from another. For example, within the scope defined by the present disclosure, a “first” element may be referred to as a “second” element, and similarly, a “second” element may be referred to as a “first” element. Singular forms are intended to include plural forms as well, unless the context clearly indicates otherwise.

It will be further understood that the terms “comprises” and/or “has”, when used in this specification, specify the presence of stated features, integers, steps, operations, elements, components or combinations thereof, but do not preclude the presence or addition of one or more other features, integers, steps, operations, elements, components, or combinations thereof. In addition, it will be understood that, when an element such as a layer, film, region or substrate is referred to as being “on” another element, it can be directly on the other element, or an intervening element may also be present. It will also be understood that when an element such as a layer, film, region or substrate is referred to as being “under” another element, it can be directly under the other element, or an intervening element may also be present.

Unless the context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures, among other things. For this reason, it should be understood that, in all cases, the term “about” should be understood to modify all numbers, figures and/or expressions. In addition, when numerical ranges are disclosed in the description, these ranges are continuous, and include all numbers from the minimum to the maximum, including the maximum within each range, unless defined otherwise. Furthermore, when the range refers to an integer, it includes all integers from the minimum to the maximum, including the maximum within the range, unless otherwise defined.

It should be understood that, in the specification, when a range is referred to regarding a parameter, the parameter encompasses all figures including end points disclosed within the range. For example, the range of “5 to 10” includes figures of 5, 6, 7, 8, 9, and 10, as well as arbitrary sub-ranges, such as ranges of 6 to 10, 7 to 10, 6 to 9, and 7 to 9, and any figures, such as 5.5, 6.5, 7.5, 5.5 to 8.5, and 6.5 to 9, between appropriate integers that fall within the range. In addition, for example, the range of “10% to 30%” encompasses all integers that include numbers such as 10%, 11%, 12%, and 13%, as well as 30%, and any sub-ranges, such as 10% to 15%, 12% to 18%, or 20% to 30%, as well as any numbers, such as 10.5%, 15.5%, and 25.5%, between appropriate integers that fall within the range.

In one aspect, the present disclosure relates to a method of preparing a bio-polyol including mixing coffee by-products including coffee grounds with a polyol solvent mixture.

As used herein, the term “coffee by-products” may include coffee grounds.

“Coffee grounds” may be used interchangeably with “coffee waste” and “coffee pucks” and may mean residues remaining after green coffee beans are carbonized (roasted) at a high temperature to obtain coffee beans, the coffee beans are mechanically ground to obtain coffee powder, and coffee is extracted from the coffee powder with hot water. The coffee waste may be, for example, a by-product remaining after extracting coffee with an espresso machine or a coffee machine for drip coffee. Coffee grounds, which are the residues remaining after roasting green coffee beans and extracting coffee with high-temperature water, may include carbon, semi-graphene, and carbon quantum dots (CQD) carbonized from the entirety or part of cellulose, a polysaccharide constituting green coffee beans and, at the same time, components such as organic matter may be removed by water during coffee extraction.

The coffee by-product may have a particle size of 20 mesh or more, 30 mesh or more, or 40 mesh or more, for example, may have a particle size of 40 mesh or more, but is not limited thereto.

The coffee by-product may include coffee grounds dried at 80° C. or higher, 90° C. or higher, 100° C. or higher or 105° C. or higher, but is not limited thereto.

The coffee by-product may include coffee grounds dried for 6 hours or longer, 12 hours or longer, 18 hours or longer, or 24 hours or longer, but is not limited thereto.

The coffee by-product may be stored at 100° C. or less, 90° C. or less, 80° C. or less or 70° C. or less after drying, but is not limited thereto.

In one embodiment, the coffee by-product may include coffee grounds stored at 70° C. after drying at 105° C. for 24 hours.

The mixing of the polyol solvent mixture may be performed at 135 to 200° C., at 150 to 185° C., or at 170° C., for example, at 170° C., but is not limited thereto.

The mixing the polyol solvent mixture is performed for 0.5 to 48 hours, for 0.5 to 24 hours, for 0.5 to 12 hours, for 0.5 to 6 hours, for 0.5 to 3 hours, for 0.5 to 2 hours, for 1.5 to 48 hours, for 1.5 to 24 hours, for 1.5 to 12 hours, for 1.5 to 6 hours, for 1.5 to 3 hours, or for 1.5 to 2 hours. For example, the mixing of the polyol solvent mixture is performed for 1.5 hours to 2 hours, but is not limited thereto.

In one embodiment, the mixing of the polyol solvent mixture may be performed at 135 to 200° C. for 0.5 to 48 hours.

In one embodiment, the mixing of the polyol solvent mixture may be performed at 170° C. for 1.5 to 2 hours.

The polyol solvent mixture may contain a polyol, glycerol, and an acid.

The polyol may have a weight average molecular weight of 400 to 8,000 g/mol, 500 to 7,000 g/mol, or 6,000 g/mol, for example, 6,000 g/mol, but is not limited thereto.

The polyol may have a hydroxyl value of 26 to 300 mgKOH/g, 27 to 290 mgKOH/g, or 280 mgKOH/g, for example, 280 mgKOH/g, but is not limited thereto.

The polyol may contain ethylene oxide (EO) in an amount of 10 to 30% by weight, 18 to 22% by weight, or 20% by weight, for example, 20% by weight, based on the total weight of the polyol, but is not limited thereto.

In one embodiment, the polyol has a weight average molecular weight of 400 to 8,000 g/mol, a hydroxyl value of 26 to 300 mgKOH/g, and contains ethylene oxide (EO) in an amount of 10 to 30% by weight, based on the total weight of the polyol.

The glycerol is an alcohol composed of three hydroxyl groups (—OH) and can be widely used in various industries. For example, glycerol is used as a moisturizer, emulsifier, or antioxidant in skin care and cosmetics, and also refers to an ingredient used in drug delivery systems, and food, pharmaceutical and chemical industries.

The acid may include at least one selected from the group consisting of sulfuric acid, adipic acid, phthalic acid, succinic acid, and maleic acid, for example, it may include sulfuric acid, but is not limited thereto.

The polyol solvent mixture may contain the polyol in an amount of greater than 50.1%, greater than 55%, greater than 65%, greater than 70%, greater than 75%, or greater than 80% by weight, based on the total weight of the polyol solvent mixture, but is not limited thereto. When the polyol is used in an amount of 50.1% by weight or less, there may be difficulty in extracting bio-polyols due to high viscosity during the reaction.

The polyol solvent mixture may contain the glycerol in an amount of 0.1 to 8%, 0.1 to 7%, 0.1 to 6%, 0.1 to 6.7%, more than 0.1% by weight and not more than 8% by weight, more than 0.1% by weight and not more than 7% by weight, or more than 0.1% by weight and not more than 6.7%, based on the total weight of the polyol solvent mixture, but is not limited thereto.

The glycerol is a substance that has a lower viscosity and lower weight average molecular weight than a polyol and acts as an initiator of liquefaction for extracting a bio-polyol from coffee by-products. When the polyol solvent mixture contains the glycerol in an amount of 0.1% by weight or less based on the total weight of the polyol solvent mixture, it is difficult for the polyol solvent mixture to act as an initiator for liquefaction, and when the polyol solvent mixture contains the glycerol in an amount of higher than 8% by weight, the surface or properties of polyurethane foams formed with bio-polyol obtained by the liquefaction may be damaged.

As used herein, the term “bio-polyol” may mean a polyol obtained from a natural product. The bio-polyol or coffee polyol may refer to a polyol obtained from coffee, coffee by-products, or the like.

The polyol-solvent mixture may contain the acid in an amount of 0.8 to 4% by weight, or more than 0.8% by weight and not more than 4% by weight, based on the total weight of the polyol-solvent mixture, but is not limited thereto. When the polyol solvent mixture contains the acid in an amount of more than 0.8% by weight and not more than 4% by weight, extraction time of polyols from coffee by-products can be accelerated and extraction time can be shortened. When the polyol solvent mixture contains the acid in an amount of not more than 0.8% by weight, the liquefaction does not proceed or slowly proceeds, resulting in a decrease in production efficiency, and when the polyol solvent mixture contains the acid in an amount of more than 4% by weight, blowing properties of urethane foams, such as sound absorption rate and compressive strength, may be deteriorated.

In the mixing of the polyol solvent mixture, the coffee by-products and the polyol solvent mixture may be mixed in a ratio of 20:80 to 45:55, but is not limited thereto.

The method of preparing a bio-polyol may further include dispersing the polyol solvent mixture in a fractionation solvent, removing unreacted coffee by-products through a filter paper, and evaporating the fractionation solvent to obtain a bio-polyol.

In another aspect, the present disclosure relates to a polyurethane resin composition containing a polyol system including the bio-polyol obtained by the method of preparing the bio-polyol, a first polyol, and a second polyol, an additive including a cell opener, a surfactant, a catalyst, a chain extender, a crosslinking agent and a blowing agent, and isocyanate, wherein the catalyst includes a gelling catalyst and a blowing catalyst.

The polyol system may include the bio-polyol, the first polyol, and the second polyol.

The polyol system may include the bio-polyol in an amount of 5 to 80 parts by weight, 5 to 70 parts by weight, 5 to 60 parts by weight, 5 to 50 parts by weight, or 5 to 40 parts by weight, based on 100 parts by weight of the total weight of the first polyol and the second polyol, but is not limited thereto. When the polyol system includes the bio-polyol in an amount of more than 80 parts by weight, based on 100 parts by weight of the total weight of the first polyol and the second polyol, it may be difficult to obtain physical properties such as sound absorption coefficient and compressive strength of the polyurethane foam according to the present disclosure.

The first polyol and the second polyol are types of polyether or polyester polyol and polymer polyol, respectively, and may react with isocyanate to contribute to the formation of polyurethane.

The polyurethane resin composition may contain the isocyanate in an amount of 30 to 180 parts by weight or 50 to 160 parts by weight, based on 100 parts by weight of the total of the polyol system and the additive, but is not limited thereto.

The polyurethane resin composition may be prepared by mixing the polyol system with the additive and the isocyanate.

When the polyurethane resin composition contains the isocyanate in an amount of 30 to 70 parts by weight, 40 to 60 parts by weight, or 50 parts by weight, based on 100 parts by weight of the total weight of the polyol system and the additive, the polyurethane foam formed from the polyurethane resin composition may be flexible.

When the polyurethane resin composition contains the isocyanate in an amount of 140 to 180 parts by weight, 150 to 170 parts by weight, or 160 parts by weight, based on 100 parts by weight of the total weight of the polyol system and the additive, the polyurethane foam formed from the polyurethane resin composition may be semi-rigid.

As used herein, the term “polyurethane foam” refer to a foam formed from polyester or polyether through a urethane reaction.

As used herein, the term “urethane reaction” may refer to a process of forming a urethane bond through a chemical reaction between isocyanate and alcohol or polyol. The isocyanate may include a —N═C═O group to open a double bond during a urethane reaction thereby to form a new urethane bond, and the polyol may include a plurality of —OH groups to form several urethane bonds.

The polyurethane foam may be classified into a flexible foam, a semi-rigid foam and a rigid foam based on density and hardness. The criteria for the classification may be changed depending on the industrial field (e.g., automobile parts, building materials, furniture) or the purpose of use or application (e.g., sound absorbing materials).

The additive may include 0.1 to 5 parts by weight of the cell opener, 0.1 to 2 parts by weight of the surfactant, 0.1 to 5 parts by weight of the catalyst, and 0.1 to 1 part by weight of the chain extender, 0.1 to 1 part by weight of the crosslinking agent, and 0.1 to 5 parts by weight of the blowing agent, based on 100 parts by weight of the polyol system, but is not limited thereto.

The catalyst may include a gelling catalyst and a blowing catalyst.

The catalyst may include the gelling catalyst in an amount of 0.05 to 4 parts by weight, 0.05 to 2 parts by weight, 0.05 to 1 part by weight, 0.5 to 4 parts by weight, 0.5 to 2 parts by weight, or 0.5 to 1 part by weight, based on 100 parts by weight of the first polyol and the second polyol, but is not limited thereto.

The catalyst may include the blowing catalyst in an amount of 0.05 to 1 part by weight, 0.05 to 0.5 parts by weight, 0.05 to 0.3 parts by weight, or 0.05 to 0.15 parts by weight, based on 100 parts by weight of the total weight of the first polyol and the second polyol, but is not limited thereto.

The additive may include the surfactant in an amount of 0.1 to 2 parts by weight based on 100 parts by weight of the polyol system. The surfactant may lower the surface tension of the urethane system during blowing of urethane foams to promote cell growth and thereby improve the structural stability of the foam. When the surfactant is present in an amount of less than 0.1 parts by weight, the polyurethane foam may be structurally unstable and collapsed, and when the surfactant is present in an amount of higher than 2 parts by weight, it may be difficult to obtain physical properties such as sound absorption coefficient and compressive strength of the polyurethane foam according to the present disclosure. The surfactant may include at least one surfactant and may be, for example, heterogeneous surfactants having different contents.

The additive may include the blowing agent in an amount of 0.1 to 5 parts by weight, based on 100 parts by weight of the polyol system. The blowing agent may produce carbon dioxide gas during the urethane reaction when polyurethane foam is formed. The blowing agent may include water. When the blowing agent is present in an amount of less than 0.1 parts by weight, blowing may not occur, and when the blowing agent is present in an amount of more than 5 parts by weight, there may be a problem in which the foam collapses during the blowing process.

The isocyanate may include at least one selected from the group consisting of methylene diphenyl diisocyanate (MDI), polymeric methylene diphenyl diisocyanate, toluene diisocyanate (TDI), hexamethylene diisocyanate, trimethyl hexamethylene diisocyanate, phenylene diisocyanate, dimethyl diphenyl diisocyanate, tetramethylene diisocyanate, isophorone diisocyanate, naphthalene diisocyanate and triphenyl methane triisocyanate, but is not limited thereto.

The polyurethane resin composition may contain the isocyanate in an amount of 0.5 to 20 times the total weight of the polyol system and the additive, and the ratio may be appropriately adjusted in consideration of the use of polyurethane foam, and the equivalence ratio of the polyol system including the bio-polyol, the first polyol, and the second polyol.

In another aspect, the present disclosure relates to a method of preparing a polyurethane resin composition including mixing coffee by-products including coffee grounds with a polyol solvent mixture to prepare a bio-polyol, mixing the bio-polyol with a first polyol, a second polyol, a cell opener, a surfactant, a catalyst, a chain extender, a crosslinking agent, and a blowing agent to prepare a polyol premix, mixing the polyol premix with isocyanate to prepare a polyurethane resin composition, and blowing the polyurethane resin composition.

The preparing a bio-polyol may include contents substantially overlapping with the method of preparing a bio-polyol and description of the overlapping contents may be omitted.

The preparing the polyurethane resin composition may include stirring the polyol premix at 1,400 to 1,600 rpm for at least 15 seconds and then mixing the polyol premix with isocyanate, but is not limited thereto.

The polyol premix may be a mixture obtained by mixing the bio-polyol, the first polyol, the second polyol, the cell opener, the surfactant, the catalyst, the chain extender, the crosslinking agent, and the blowing agent.

The preparing the polyurethane resin composition may include mixing the polyol premix with isocyanate in an amount of 0.5 to 20 times the total weight of the polyol premix, but is not limited thereto.

The blowing may be performed using a known blowing cup, constant-temperature water bath, blowing mold, or the like.

The blowing may be performed by adding isocyanate to the polyol premix, followed by stirring at high speed for a short time.

The polyurethane foam obtained as a semi-rigid foam by the method of preparing a polyurethane has a compressive strength of 0.5 kgf/cm² or more, 0.52 kgf/cm² or more, 0.54 kgf/cm² or more, 0.56 kgf/cm² or more, 0.58 kgf/cm² or more, or 0.6 kgf/cm² or more, for example, 0.6 kgf/cm² or more, but is not limited thereto.

The polyurethane foam obtained as a soft foam by the method of preparing a polyurethane foam has a compressive strength of 0.1 to 0.14 kgf/cm², 0.1 to 0.13 kgf/cm², 0.1 to 0.12 kgf/cm², 0.2 to 0.14 kgf/cm², 0.2 to 0.13 kgf/cm², or 0.2 to 0.12 kgf/cm², for example, 0.2 to 0.12 kgf/cm², but is not limited thereto.

Hereinafter, the present disclosure will be described in more detail with reference to preparation examples and experimental examples. However, the following preparation examples and experimental examples are provided only for better understanding of the present disclosure and thus should not be construed as limiting the scope of the present disclosure. Preparation Example 1: Preparation of coffee grounds-based polyols

All ingredients excluding spent coffee grounds (SCG) from the mixing ingredients shown in Table 1 were weighed in contents in Table 1 in a 3-neck flask, and then heated using a hot plate and oil bath in the presence of nitrogen gas at 170° C. and 480 rpm for 30 minutes.

The SCG obtained by screening through a 40 mesh sieve, drying at 105° C. for 24 hours and storing at 70° C. was weighed, injected into the heated 3-neck flask, and then liquefied for a predetermined reaction time shown in Table 1. The reaction product was cooled to room temperature, dispersed in ethanol, and filtered through filter paper and a vacuum pump.

The unreacted SCG left on the filter paper was dried in an oven at 70° C. or higher overnight and the conversion (%) was calculated in accordance with the following equation.

$$Conversion ( \% ) = [ \{ ( weight of SCG before reaction - weight of unreacted SCG after completion of reaction ) \} \text{} / weight of SCG before reaction ] \times 100 \qquad Equation 1$$

Meanwhile, ethanol was removed from the solution, from which the unreacted SCG has been removed by filtration, using a rotary evaporator at 95° C. or higher, and was placed in a vial on a flat site where shaking does not occur for one day or longer and the phase of the coffee polyol was observed.

TABLE 1

| | Composition (g) | | | | | | | | |
|---|---|---|---|---|---|---|---|---|---|
| | | GPX- | GPX- | | Sulfuric | SCG | | | Reaction |
| Item | PEG | 600 | 6000 | Glycerol | acid | (a) | (b) | (c) | time (hr) |
| Example 1 | — | 81 | — | 9 | 2.7 | 30 | — | — | 1.5 |
| Example 2 | — | 81 | — | 9 | 2.7 | 30 | — | — | 2 |
| Example 3 | — | — | 81 | 9 | 2.7 | 30 | — | — | 1.5 |
| Example 4 | — | — | 81 | 9 | 2.7 | 30 | — | — | 2 |
| Example 5 | — | 81 | — | 9 | 2.7 | — | 30 | — | 1.5 |
| Example 6 | — | 81 | — | 9 | 2.7 | — | 30 | — | 2 |
| Example 7 | — | — | 81 | 9 | 2.7 | — | 30 | — | 1.5 |
| Example 8 | — | — | 81 | 9 | 2.7 | — | 30 | — | 2 |
| Example 9 | — | 81 | — | 9 | 2.7 | — | — | 30 | 1.5 |
| Example 10 | — | 81 | — | 9 | 2.7 | — | — | 30 | 2 |
| Example 11 | — | — | 81 | 9 | 2.7 | — | — | 30 | 1.5 |
| Example 12 | — | — | 81 | 9 | 2.7 | — | — | 30 | 2 |
| Example 13 | — | 81 | — | 9 | 2.7 | — | 30 | — | 0.5 |
| Example 14 | — | 81 | — | 9 | 2.7 | — | 30 | — | 1 |
| Example 15 | — | 81 | — | 9 | 2.7 | — | 30 | — | 4 |
| Example 16 | — | 81 | — | 9 | 2.7 | — | 30 | — | 6 |
| Example 17 | — | 81 | — | 9 | 2.7 | — | 30 | — | 24 |
| Example 18 | — | — | 270 | 30 | 9 | — | 30 | — | 1.5 |
| Example 19 | — | — | 270 | 30 | 9 | — | 10 | — | 1.5 |
| Example 20 | — | — | 270 | 30 | 9 | — | 10 | — | 2 |
| Example 21 | — | — | 270 | 30 | 9 | — | 10 | — | 4 |
| Example 22 | — | — | 270 | 30 | 9 | — | 10 | — | 6 |
| Example 23 | — | — | 270 | 30 | 9 | — | 10 | — | 24 |
| Example 24 | | 81 | | 9 | 3.6 | | 30 | | 1.5 |
| Example 25 | | 81 | | 9 | 3.6 | | 30 | | 2 |
| Comparative | 81 | — | — | 9 | 2.7 | 30 | — | — | 1.5 |
| Example 1 | | | | | | | | | |
| Comparative | 81 | — | — | 9 | 2.7 | 30 | — | — | 2 |
| Example 2 | | | | | | | | | |
| Comparative | 81 | — | — | 9 | 2.7 | — | 30 | — | 1.5 |
| Example 3 | | | | | | | | | |
| Comparative | 81 | — | — | 9 | 2.7 | — | 30 | — | 2 |
| Example 4 | | | | | | | | | |
| Comparative | 81 | — | — | 9 | 2.7 | — | — | 30 | 1.5 |
| Example 5 | | | | | | | | | |
| Comparative | 81 | — | — | 9 | 2.7 | — | — | 30 | 2 |
| Example 6 | | | | | | | | | |

Types of spent coffee grounds (SCG): (a) mixed; (b) Colombia Narino Supremo; and (c) Ethiopia Koke Honey Yirgacheffe.

TABLE 2

Result

| Item | Phase | Conversion (%) |
|---|---|---|
| Example 1 | 2 | 47.8 |
| Example 2 | 2 | 52.2 |
| Example 3 | 1 | 6.2 |
| Example 4 | 1 | 7 |
| Example 5 | 1 | 56.9 |
| Example 6 | 1 | 57.1 |
| Example 7 | 1 | 16.8 |
| Example 8 | 1 | 16.4 |
| Example 9 | 1 | 55.8 |
| Example 10 | 1 | 57.3 |
| Example 11 | 1 | 13.7 |
| Example 12 | 1 | 14.2 |
| Example 13 | 1 | 47.9 |
| Example 14 | 1 | 54.5 |
| Example 15 | 1 | 60.7 |
| Example 16 | 1 | 64.3 |
| Example 17 | 1 | 67.8 |
| Example 18 | 1 | 26.7 |
| Example 19 | 1 | 29.5 |
| Example 20 | 1 | 31.1 |
| Example 21 | 1 | 34.3 |
| Example 22 | 1 | 34.5 |
| Example 23 | 1 | 37.4 |
| Example 24 | 1 | 63.2 |
| Example 25 | 1 | 65.3 |
| Comparative Example 1 | 2 | 47.7 |
| Comparative Example 2 | 2 | 56.1 |
| Comparative Example 3 | 2 | 78.6 |
| Comparative Example 4 | 2 | 82.2 |
| Comparative Example 5 | 2 | 75.0 |
| Comparative Example 6 | 2 | 76.6 |

As can be seen from Table 1 and Table 2, Examples 1 and 2, Examples 5 and 6, Examples 9 and 10, Examples 13 to 17, and Examples 24 and 25 using GPX-600 (Mw=600, 20% ethylene oxide in polyol, hydroxyl value of 280 mgKOH/g) have higher conversion (%) of 47.8 to 67.8%. Thereamong, Examples 1 and 2 using mixed coffee grounds have two phases and have a problem of requiring an additional separation process, while Examples 5 and 6, Examples 9 and 10, Examples 13 to 17, and Examples 24 and 25 have one phase and are advantageously applicable to processing without an additional separation process.

In addition, Examples 3 and 4, Examples 7 and 8, and Examples 11 and 12 using GPX-6000 (Mw=6,000, 15% ethylene oxide in polyol, hydroxyl value of 28 mgKOH/g), which is one of polyols used as raw materials for producing urethane foams, in the equal weight as GPX-6004, have a conversion rate of only 6.2 to 16.8%. However, Examples 18 to 23 obtained by conducting the experiment in accordance with the equivalence ratio defined in the present disclosure have a higher conversion rate in the range of 26.7 to 37.4%. All of the polyols of Examples using GPX-6000 appeared in one phase.

Comparative Examples 1 to 6 had a conversion rate in the range of 47.7 to 82.2%, which was similar to or higher than that of GPX-600, but all of them were observed in two phases and had a problem of requiring an additional separation process.

“One phase” and “two phases” in the polyol system are terms that indicate how the ingredients in the system are separated in a mixed state. “One phase” may mean that all ingredients are mixed to form a single state and “two phases” may mean that two or more ingredients are separated from each other and thus are present in different states. The two phases may require an additional separation process to obtain only a specific polyol because the polyol and other ingredient have different physical properties.

It can be seen from the results that a combination of single coffee beans and GPX-600 polyol as a solvent is present in one phase, which does not require an additional separation process and has a high conversion rate, thus being the most useful for producing urethane foams with an increased biomass content. Thereamong, the polyol of Example 5 having the highest conversion rate among Examples having the shortest reaction time was used to blow polyurethane foams in Preparation Example 2 described below and then the physical properties thereof were evaluated.

### Preparation Example 2. Preparation of Polyurethane Foams Containing Coffee Grounds-Based Polyol

Polyurethane foams were blown with the polyol of Example 5 and blowing time and physical properties thereof were evaluated. Examples of the mixing of the polyurethane resin composition for blowing are shown in Table 3. Specifically, a first polyol including GPX-6000 (a polyether polyol having a weight average molecular weight Mw=6,000 g/mol, a 15 wt % ethylene oxide in polyol and a hydroxyl value of 28 mgKOH/g), a second polyol including POP-6040 (polymer polyol) having a hydroxyl value of 20 mgKOH/g and containing 40% by weight of a solid filler, a cell opener including GEX-3300, a surfactant including L-3002 (Momentive) and L-5309 (Momentive), a blowing catalyst including ETF (Tosoh), a gelling catalyst including Dabco-33LV (33% triethylenediamine and 67% dipropylene glycol; Air Products and Chemicals, USA), a chain extender including 1,4-butylene glycol (1,4-BG), a crosslinking agent including diethanolamine (DEOA), and a blowing agent including water were used.

As shown in Table 3, the polyol premix (X) was injected into a blowing cup and the liquid temperature was set to 25° C. in a water bath. Isocyanate (Y) was weighed in another container to adjust an equivalent ratio of isocyanate (Y) and the polyol premix to 1:1.6 or 2:1 and the liquid temperature was adjusted to 25° C. The polyol solvent mixture was stirred at 1,500 rpm for 15 seconds or more, isocyanate was added thereto, and the resulting mixture was stirred at 3,000 rpm for less than 5 seconds, and then poured into a blowing mold.

TABLE 3

| | | | | | | | Comparative | Comparative | Comparative |
|---|---|---|---|---|---|---|---|---|---|
| Item (parts by | | Example | Example | Example | Example | Example | Example | Example | Example |
| weight, phr) | | 26 | 27 | 28 | 29 | 30 | 7 | 8 | 9 |
| (X) | First | 60 | 60 | 60 | 60 | 60 | 70 | 70 | 60 |
| | polyol | | | | | | | | |
| | Second | 30 | 30 | 30 | 30 | 30 | 30 | 30 | 30 |
| | polyol | | | | | | | | |
| | Example 5 | 10 | 10 | 10 | 10 | 10 | — | — | — |
| | polyol | | | | | | | | |
| | Comparative | — | — | — | — | — | — | — | 10 |
| | Example 3 | | | | | | | | |
| | polyol | | | | | | | | |
| | Cell | 2 | 2 | 2 | 2 | 2 | 2 | 2 | 2 |
| | opener | | | | | | | | |
| | First | 0.4 | 0.4 | 0.4 | 0.4 | 0.4 | 0.4 | 0.4 | 0.4 |
| | surfactant | | | | | | | | |
| | Second | 0.2 | 0.2 | 0.2 | 0.2 | 0.2 | 0.2 | 0.2 | 0.2 |
| | surfactant | | | | | | | | |
| | Blowing | 0.15 | 0.15 | 0.15 | 0.15 | 0.15 | 0.15 | 0.15 | 0.15 |
| | catalyst | | | | | | | | |
| | Gelling | 0.5 | 0.5 | 0.6 | 0.8 | 1.0 | 0.5 | 0.5 | 0.5 |
| | catalyst | | | | | | | | |
| | Chain | 0.2 | 0.2 | 0.2 | 0.2 | 0.2 | 0.2 | 0.2 | 0.2 |
| | extender | | | | | | | | |
| | Crosslinking | 0.5 | 0.5 | 0.5 | 0.5 | 0.5 | 0.5 | 0.5 | 0.5 |
| | agent | | | | | | | | |
| | Blowing | 3.8 | 3.8 | 3.8 | 3.8 | 3.8 | 3.8 | 3.8 | 3.8 |
| | agent | | | | | | | | |

| | | | | | | | | |
|---|---|---|---|---|---|---|---|---|
| (X):(Y) | 1:1.6 | 2:1 | 2:1 | 2:1 | 2:1 | 1:1.6 | 2:1 | 2:1 |

(X): Polyol premix,
(Y): Isocyanate (KI-2000)
Semi-rigid foam is formed at (X):(Y) = 1:1.6
Soft foam is formed at (X):(Y) = 2:1

The unit “parts by weight” may be based on 100 parts by weight of the total weight of the polyol system including the polyol of Example 5 or the polyol of Comparative Example 3 in the first polyol and the second polyol.

### 1-1. Height and Density

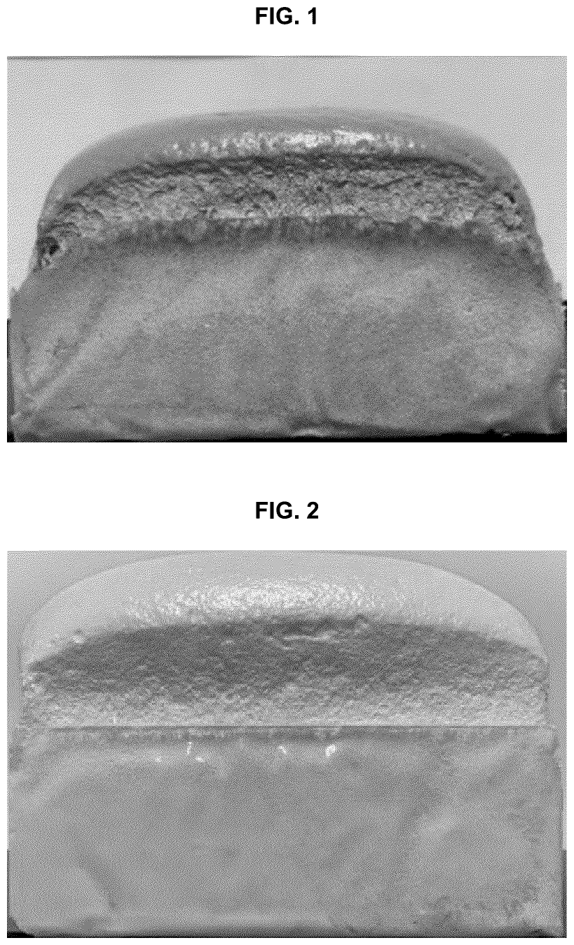

Example 26, the semi-rigid foam obtained using polyol of Example 5 was imaged and the result is shown in FIG. 1, whereas Comparative Example 7, the foam obtained without using the polyol of Example 5 is shown in FIG. 2 and the measured height and density are shown in Table 4

TABLE 4

| Item | Example 26 | Comparative Example 7 |
|---|---|---|
| Height (cm) | 14.0 | 18.0 |
| Density (kg/m³) | 26 | 20 |

As can be seen from Table 4, the height of Example 26 was 14.0 cm and the density was 26 kg/m³, which was close to the height of 18.0 cm and the density of 20 kg/m3 of Comparative Example 7.

### 1-2. Sound Absorption Coefficient

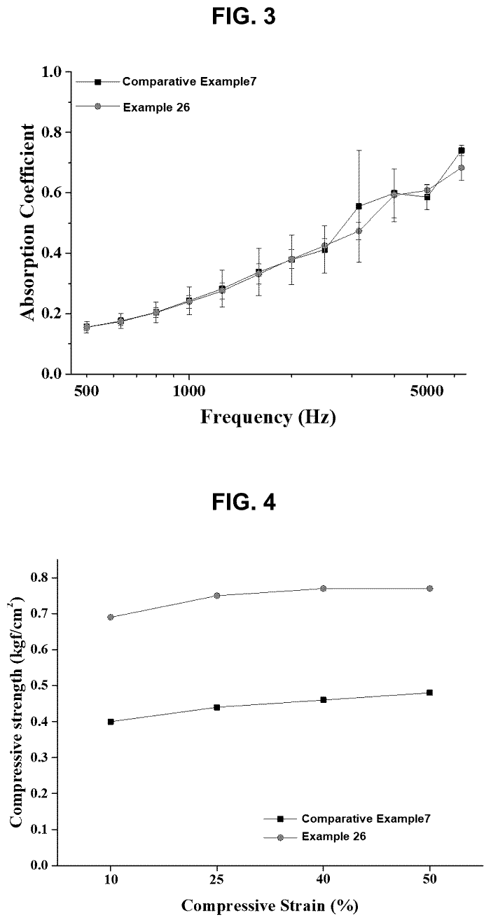

The sound absorption coefficients of Example 26 and Comparative Example 7 were measured in the section of 0.4 to 6 kHz by a tube method (29′P, 28t specimen) and evaluated as arithmetic means, and the results are shown in FIG. 3.

As can be seen from FIG. 3, the sound absorption coefficients of Example 26 and Comparative Example 7 were similar, regardless of whether or not the polyol of Example 5 was added.

### 1-3. Compressive Strength

The compressive strength of each of Example 26 and Comparative Example 7 was recorded as stress generated upon compression at 10, 25 or 50% of a 28t circular specimen with a diameter of 100 mm at a rate of 100 mm/min in accordance with ISO3386-1 and the result is shown in FIG. 4.

As can be seen from FIG. 4, the compressive strength of the foam of Example 26 including the polyol of Example 5 was about 0.77 kgf/cm², whereas the compressive strength of the foam of Comparative Example 7 was about 0.48 kgf/cm², which means that the foam of Example 26 has a compressive strength increased by about 60% and thus exhibits excellent physical properties as a semi-rigid foam.

Overall, the semi-rigid foam produced according to the present disclosure exhibited superior compressive strength and sound absorption coefficient comparable to the semi-rigid foam of the prior art.

### Experimental Example 2. Evaluation of Physical Properties—Flexible Foam

### 2-1. Height and Density

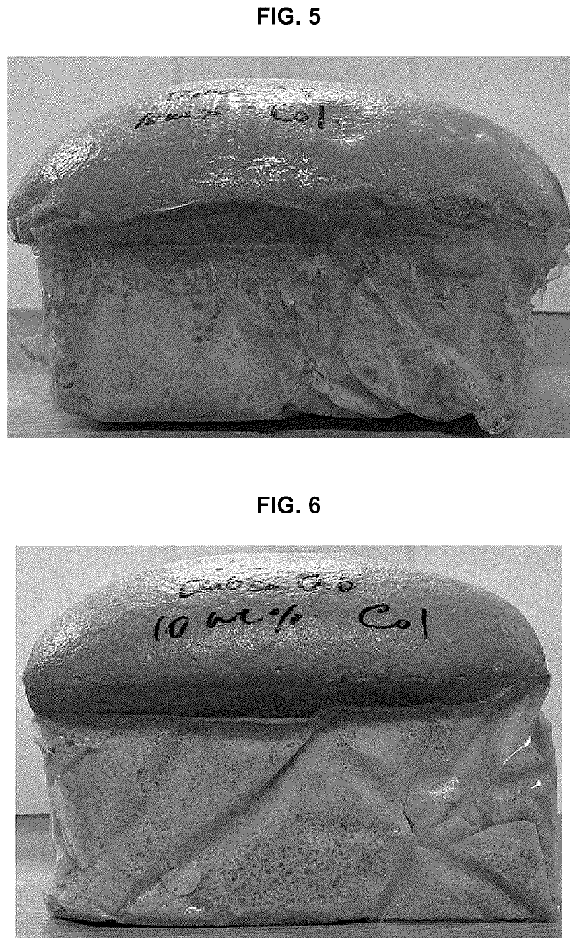

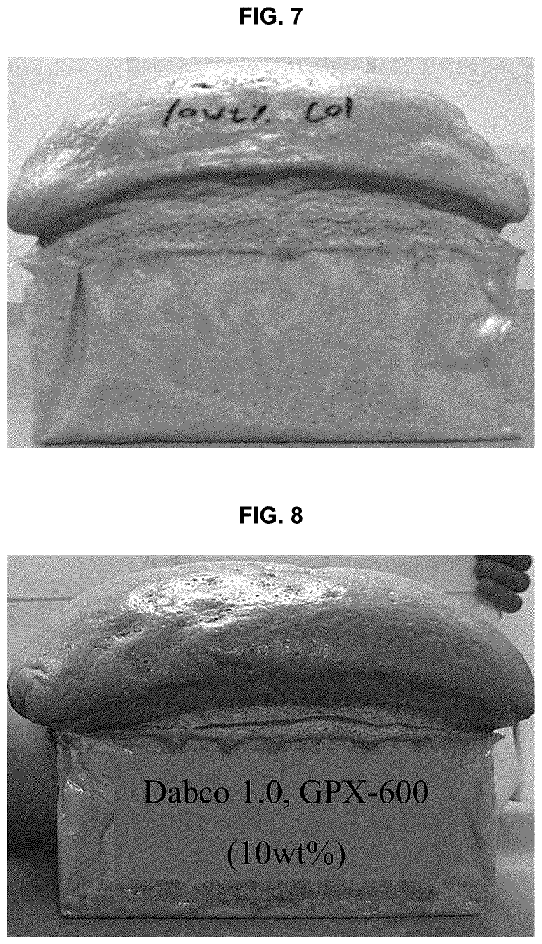

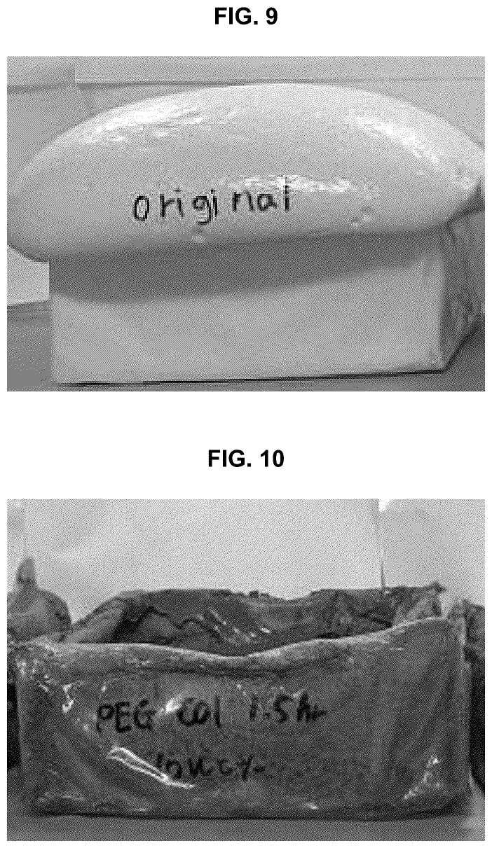

The flexible foams of Examples 27 to 30 blown using polyol of Example 5 were imaged and the results are shown in FIGS. 5 to 8, Comparative Example 8 using no polyol of Example 5 is shown in FIG. 9 for comparison, Comparative Example 9 using polyol of Comparative Example 3 is shown in FIG. 10, and the height and density are measured and shown in Table 5.

TABLE 5

| | | | | | Comparative | Comparative |
|---|---|---|---|---|---|---|
| | Example | Example | Example | Example | Example | Example |
| Item | 27 | 28 | 29 | 30 | 8 | 9 |
| Height (cm) | 17.9 | 18.4 | 20.4 | 20.2 | 18.5 | 5.5 |
| Density (kg/m³) | 57 | 45 | 33 | 32 | 35 | — |

As can be seen from Table 5, the height of the flexible foam of Example 28, was 18.4 cm, which is the closest to the height of 18.5 cm of Comparative Example 8, and the density of Example 29 was 33 kg/m³, which is the closest to the density of 35 kg/m³ of Comparative Example 8.

Comparative Example 9 using the PEG-containing polyol of Comparative Example 3, rather than the polyol of Example 5, failed to be blown normally and collapsed, resulting in a low height of 5.5 cm, and making it impossible to evaluate physical properties due to such collapse.

### 2-2. Sound Absorption Coefficient

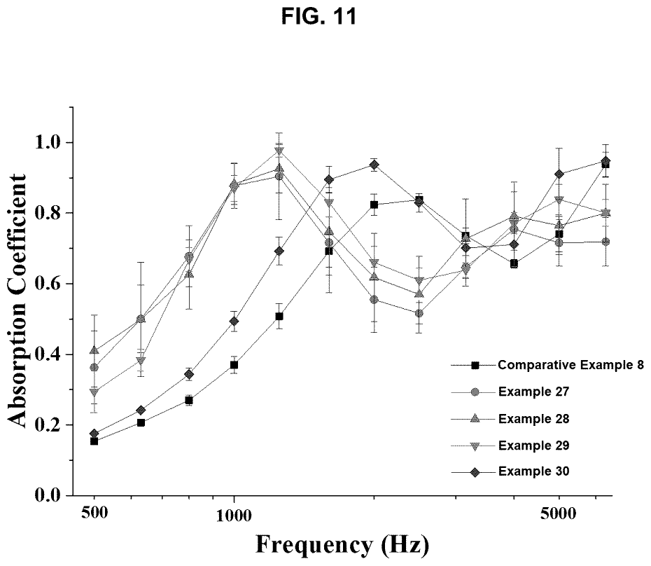

The sound absorption coefficients of the foams of Example 26 and Comparative Example 7 were measured in the section of 0.4 to 6 kHz by a tube method (29Ψ, 28t specimen) and evaluated as arithmetic means, and the results are shown in FIG. 11.

As can be seen from FIG. 11, the sound absorption coefficients at 1,600 Hz or less of the soft foams of Examples 27 to 30 were higher than those of Comparative Example 8.

### 2-3. Compressive Strength

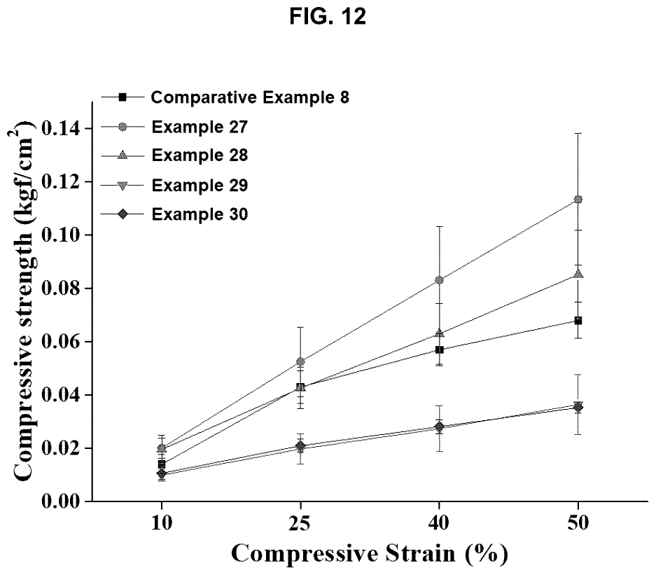

The compressive strength of Examples 27 to 30 and Comparative Example 8 was recorded as stress generated upon compression at 10, 25 or 50% of a specimen (50 mm×50 mm×25 mm) at a rate of 100 mm/min in accordance with ISO3386-1 and the result is shown in FIG. 12.

As can be seen from FIG. 12, when comparing Comparative Example 8 and Example 2, which have an equal Dabco-33LV content of 0.5 parts by weight, higher compressive strength was obtained when the polyol of Example 5 was contained. Example 28 having a Dabco content of 0.6 parts by weight still had higher compressive strength than Comparative Example 8, but when the Dabco content was increased, the compressive strength decreased. The compressive strengths of Example 29 (0.8 parts by weight of Dabco) and Example 30 (1.0 parts by weight of Dabco), which exhibit lower compressive strengths than that of Comparative Example 8, were found to be equivalent to each other.

In conclusion, the compressive strength of the flexible foam prepared according to the present disclosure can be freely adjusted by adjusting the content of the gelling catalyst.

As is apparent from the foregoing, the present disclosure is capable of directly extracting bio-polyols from coffee by-products through liquefaction using polyols, which are a raw material of urethane, thus simplifying the complicated process of extracting polyols from coffee and completing extraction of bio-polyols within a short time of only about 1.5 to 2 hours, without requiring an additional washing or phase separation process.

The present disclosure is advantageous in terms of cost and time by simplifying a series of processes for extracting bio-polyols and enables preparation of bio-polyol-based polyurethane foams having physical properties comparable to conventional polyurethane foams using petroleum-based polyols.

The effects of the present disclosure are not limited to those mentioned above. It should be understood that the effects of the present disclosure include all effects that can be inferred from the description of the present disclosure.

The present disclosure has been described in detail with reference to embodiments thereof. However, it will be appreciated by those skilled in the art that changes may be made in these examples without departing from the principles and spirit of the present disclosure, the scope of which is defined in the appended claims and their equivalents.

1. A method of preparing a bio-polyol comprising:
mixing coffee by-products including coffee grounds with a polyol solvent mixture;
wherein the polyol solvent mixture comprises a polyol, glycerol, and an acid.

2. The method according to claim 1, wherein the mixing is performed at 135 to 200° C. for 0.5 to 48 hours.

3. The method according to claim 1, wherein the polyol has a weight average molecular weight of 400 to 8,000 g/mol and a hydroxyl value of 26 to 300 mgKOH/g and comprises 10 to 30% by weight of ethylene oxide (EO), based on a total weight of the polyol.

4. The method according to claim 1, wherein the acid comprises at least one selected from the group consisting of sulfuric acid, adipic acid, phthalic acid, succinic acid, and maleic acid.

5. The method according to claim 1, wherein the polyol solvent mixture comprises the polyol in an amount of greater than 50.1% by weight, based on the total weight of the polyol solvent mixture.

6. The method according to claim 1, wherein the polyol solvent mixture comprises the glycerol in an amount of 0.1 to 8% by weight, based on the total weight of the polyol solvent mixture.

7. The method according to claim 1, wherein the polyol solvent mixture comprises the acid in an amount of 0.8 to 4% by weight, based on the total weight of the polyol solvent mixture.

8. The method according to claim 1, wherein the mixing is performed by mixing the coffee by-products and the polyol solvent mixture in a ratio of 20:80 to 45:55.

9. A polyurethane resin composition comprising:
a polyol system comprising the bio-polyol prepared by the method according to claim 1, a first polyol, and a second polyol;
an additive comprising a cell opener, a surfactant, a catalyst, a chain extender, a crosslinking agent, and a blowing agent; and
isocyanate;
wherein the catalyst comprises a gelling catalyst and a blowing catalyst.

10. The polyurethane resin composition according to claim 9, wherein the polyol system comprises the bio-polyol in an amount of 5 to 80 parts by weight, based on 100 parts by weight of the total weight of the first polyol and the second polyol.

11. The polyurethane resin composition according to claim 9, wherein the polyurethane resin composition comprises the isocyanate in an amount of 0.5 to 20 times the total weight of the polyol system and the additive.

12. The polyurethane resin composition according to claim 9, wherein the additive comprises 0.1 to 5 parts by weight of the cell opener, 0.1 to 2 parts by weight of the surfactant, 0.1 to 5 parts by weight of the catalyst, 0.1 to 1 part by weight of the chain extender, 0.1 to 1 part by weight of the crosslinking agent, and 0.1 to 5 parts by weight of the blowing agent, based on 100 parts by weight of the polyol system.

13. A method of preparing a polyurethane resin composition comprising:
mixing coffee by-products including coffee grounds with a polyol solvent mixture to prepare a bio-polyol;
mixing the bio-polyol with a first polyol, a second polyol, a cell opener, a surfactant, a catalyst, a chain extender, a crosslinking agent, and a blowing agent to prepare a polyol premix;
mixing the polyol premix with isocyanate to prepare a polyurethane resin composition; and
blowing the polyurethane resin composition.

14. The method according to claim 13, wherein preparing the polyurethane resin composition comprises mixing the polyol premix with the isocyanate after stirring the polyol premix at 1,400 to 1,600 rpm for at least 15 seconds.

15. The method according to claim 13, wherein preparing the polyurethane resin composition comprises mixing the polyol premix with the isocyanate in an amount of 0.5 to 20 times the total weight of the polyol premix.

16. The method according to claim 13, wherein the polyurethane foam obtained as a semi-rigid foam by the method has a compressive strength of 0.5 kgf/cm² or more; and
the polyurethane foam obtained as a soft foam by the method has a compressive strength of 0.1 to 0.14 kgf/cm².
